(19) United States
(12) Patent Application Publication
(10) Pub. No.: US 2010/0302976 A1
(43) Pub. Date: Dec. 2, 2010

(54) Front-End Circuit

(76) Inventor: Pasi Tikka, Uterhaching (DE)

Correspondence Address: FISH & RICHARDSON PC, P.O. BOX 1022, MINNEAPOLIS, MN, 55440-1022, US

(21) Appl. No.: 12/747,276

(22) PCT Filed: Jan. 12, 2009
(86) PCT No.: PCT/DE09/00019

§ 371 Date: Aug. 16, 2010

(30) Foreign Application Priority Data
Jan. 10, 2008 (DE) 10 2008 003 820.2

(51) Int. Cl. H04B 7/005

(52) U.S. Cl. 370/278

(57) ABSTRACT

A front-end circuit for a mobile radio includes a first Frequency Division Duplexing (FDD) transmission path for a first FDD mobile radio system, where the first FDD transmission path includes a transmission amplifier and a duplexer that includes a transmission filter element; a first Time Division Duplexing (TDD) transmission path for a first TDD mobile radio system, where the first TDD transmission path includes a transmission amplifier; an antenna connection configured for connecting to the duplexer or to the first TDD transmission path; at least one transmission filter; and a switch configuration to connect the at least one transmission filter to the first FDD transmission path or to the first TDD transmission path. The first TDD mobile radio system and the first FDD mobile radio system use a same first frequency band.

### TECHNICAL FIELD

This patent application relates to a front-end circuit for a mobile radio device with multimode operation.

### BACKGROUND

Today's mobile telephones must be able to operate in different mobile radio standards and also to serve several different frequency bands. In order to reduce the large number of different components which this requires and thus to reduce both the size and also the weight and costs of the mobile telephones, pains are taken to use components more than once as far as possible and, depending on requirements, to operate in different mobile radio systems alternately.

In this case, a mobile radio standard is understood to mean the type of signal processing and transmission and in particular how a distinction is drawn between transmitted and received signals. By way of example, TDD (time division duplexing) and FDD (frequency division duplexing) systems are known. TDD systems send and receive at different times in what are known as time slots, with sending and receiving often even taking place in different frequency bands which are switched between by switches. In FDD systems, the separation between transmitted and received signals is made exclusively by the different frequency bands used therefor in a duplexer, which is in the form of a passively operating frequency filter.

A known TDD system is the GSM system frequently used in Europe, whereas the USA and Japan make widespread use of WCDMA systems, which are FDD systems.

A known standard front-end circuit is shown by way of example in FIG. 1. This circuit can be used to operate five mobile radio systems in two different standards. A first and a second FDD system (WCDMA) operate in different frequency ranges, for example at 850 or 900 MHz and at 1800 or 1900 MHz. A frequency range respectively covers approximately one octave. Within an octave, the frequency is doubled. The two FDD systems each have a duplexer, one end of which is connected to an antenna connection and the other end of which is connected to a transmission path and a reception path respectively. The transmission path contains a further transmission filter and a transmission amplifier, while the reception path opens directly into the receiver circuit, which is in the form of an RFIC, without further filtering. All transmission and reception paths for the three TDD systems are connected to the antenna connection selectively by an antenna switch. Each TDD transmission path has a transmission amplifier and a transmission filter. The reception paths each contain just one reception filter.

Two bands in the TDD systems, which bands are situated close together and therefore within the same frequency range (e.g. 1 GHz range), use a shared transmission amplifier, to which the two transmission filters are connected selectively by a switch. The transmission path of a TDD system situated in the higher frequency range (e.g. 2 GHz range) has only one balun in this case, which has a rudimentary filter function which is sufficient for this transmission path. Thus, only one chip component is used by different mobile radio systems.

### SUMMARY

Described herein is a front-end circuit for at least one FDD system and at least one TDD system, which use a shared band, wherein a transmission filter can be connected either to the transmission path of the TDD system or to the transmission path of the FDD system. In comparison with the known circuit from FIG. 1, one transmission filter is thus saved. The transmission filter is used for filtering out undesirable frequency components, e.g. the harmonics which occur at relatively high frequencies or the noise from the transmission amplifier. This function can be performed by the shared transmission filter for both mobile radio systems, which belong to different standards.

The front-end circuit therefore saves one transmission filter and hence cost and complexity and allows a further reduction in the necessary substrate size or module size.

A front-end circuit which is designed for operation in a first TDD mobile radio system and in a first FDD mobile radio system, both of which use the same band, therefore comprises a first FDD transmission path for the first FDD mobile radio system, which contains a transmission amplifier and the transmission filter element of a duplexer. A first TDD transmission path for the first TDD mobile radio system contains a transmission amplifier. An antenna connection can be connected either to the duplexer or to the first TDD transmission path. A (shared) transmission filter can be connected either to the first FDD transmission path or to the first TDD transmission path by switching means.

The number of transmission amplifiers required can vary in the front-end circuit. Usually, but not necessarily, associated mobile radio systems for different mobile radio standards have a separate transmission amplifier assigned per band or per frequency range.

In one embodiment, a respective transmission amplifier is therefore provided for the FDD mobile radio system and the TDD mobile radio system. The switching means then connects the transmission filter either to the transmission amplifier in the FDD transmission path or to the transmission amplifier in the TDD transmission path.

In a further embodiment, a shared transmission amplifier is provided for the FDD transmission path and the TDD transmission path. The switching means then connects the shared transmission amplifier either to the transmission filter element of the duplexer or to the antenna connection. Whereas the transmission path of the TDD system does not require further filtering of the transmitted signal downstream of the transmission amplifier, the transmitted signal in the FDD system must still pass through the transmission filter element of the duplexer.

The proposed front-end circuit can be extended by components for further mobile radio systems. It is thus possible for a second transmission filter to be provided for a second TDD mobile radio system, which operates in a second band that is adjacent to the first band. The switching means connects either the first or the second transmission filter either to the first FDD transmission path or to the first TDD transmission path.

In this embodiment, different transmission filters are thus used for adjacent bands. Depending on the band which the FDD system matches, one of the two transmission filters can be selectively used for the transmission path of the first FDD system. The option of choosing between two transmission filters allows the front-end circuit to be designed such that it can alternatively be fitted with duplexers which operate in the first or second band, without this requiring the circuit environment to be adapted.

In contrast to the shared use of transmission paths or of parts of the transmission paths, a separate TDD reception path may be provided per TDD mobile radio system. The signal processing and production take place in the transmission/reception IC transceiver—which is connected to all transmission and reception paths. In this arrangement, it is possible for each path to have been assigned a separate input or output on the transceiver. However, it is also possible for only one transmission output to be provided per frequency range. If said transmission output opens into different transmission paths, a switch for switching to the different transmission paths may be provided. However, it is also possible for the transmission paths to be connected in parallel to the relevant shared output on the transceiver.

The reception paths of different mobile radio systems in different standards can also be connected in parallel to a shared reception input, but can also be allocated separately from one another to different inputs on the transceiver.

The transceiver can process symmetric and/or asymmetric signals and may accordingly have balanced or unbalanced outputs. Since the antenna usually requires a single-ended (unbalanced) signal, a balun needs to be provided in the relevant path in the case of a symmetric transceiver connection. Modern filters based on SAW or BAW filters already have a balun functionality when manufactured, which means that no additional baluns are required even when the transceiver operates in symmetric fashion.

The at least one transmission filter may have a symmetric input and an unbalanced output. Accordingly, the reception filters may have an unbalanced input and a symmetric output.

The front-end circuit may also contain a plurality of FDD mobile radio systems. Thus, in the front-end circuit, a second duplexer for a second FDD mobile radio system may operate in a second band, which corresponds to the second band of the second TDD system, for example. The transmission filter element of the second duplexer is arranged in a second FDD transmission path. The switching means of the front-end circuit can then connect the first or second transmission filter either to the first or to the second FDD transmission path or to the TDD transmission path.

In line with a further embodiment, a third TDD mobile radio system and a third FDD mobile radio system may be provided, both of which use the same band, which is different than the first band by one octave, however, and therefore belongs to another frequency range. Whereas the first frequency range covers frequencies of 600-1000 MHz, for example, the second frequency range may cover frequencies of 1.5-2 GHz, for example. The transmission paths of these two third mobile radio systems may also have a shared third transmission filter provided for them which can be connected by switching means either to the third TDD transmission path or to the third FDD transmission path.

Parts of the front-end circuit may be in the form of a module or submodule. A module is distinguished by a shared module substrate, an interconnection arranged therein or thereon and also possibly passive matching components and circuit components which can be protected under a shared encapsulation or cover. The split into submodules is made on the basis of functional aspects and compatibility of the components. By way of example, antenna switches and transmission amplifiers in the TDD mobile radio systems may be arranged on a shared power switch module. A module which additionally comprises filters can also be referred to as a front-end module.

In line with one embodiment, the first and second transmission filters are in the form of 2-in-1 filters. These are two filters which are produced on a substrate, particularly using the same filter technology, and are connected in parallel to a shared input, for example. This saves further module or board area.

The filters are implemented using a filter technology which meets the requirements of the respective mobile radio standard. The highest demands and hence also the highest-quality filters are required for the duplexers in the FDD systems (e.g. WCDMA). These may be in the form of SAW or FBAR filters. It is also possible to produce transmission and reception filter elements using different technologies, so that a duplexer may have a SAW filter and an FBAR filter beside one another.

The transmission filters may be produced in a simpler construction, since such high demands are not usually placed on the bandpass properties of transmission filters. They can therefore be implemented as LC filters or naturally likewise as SAW or FBAR filters.

In one embodiment, the front-end circuit is produced on a ceramic multilayer substrate, wherein the interconnection of the filters and also matching circuits or other passive circuit components for the filters are at least partly or else completely arranged so as to be integrated in the multilayer substrate.

The switching means of the front-end circuit, e.g., the switches which assign the shared transmission filter to different transmission paths and also the antenna switches for connecting the antenna connection to the individual transmission and reception paths, are in the form of CMOS switches, PIN diodes or in the form GaAs switches and are arranged as discrete components on a the substrate of the front-end circuit.

Embodiments are explained in more detail below with reference to the associated figures. The figures serve merely as an aid to understanding the embodiments and are therefore merely schematic and not to scale. It is therefore possible to take neither relative nor absolute indications of measurements from the figures.

### DESCRIPTION OF THE DRAWINGS

FIG. 1 shows a known front-end circuit,

FIG. 2 shows a first exemplary embodiment with two transmission amplifiers for the first frequency range,

FIG. 3 shows a second exemplary embodiment with a shared transmission amplifier for the transmission paths of the first frequency range,

FIG. 4 shows a fourth exemplary embodiment with a shared transmission amplifier and components for three further mobile radio systems, and

FIG. 5 shows a third exemplary embodiment with a shared transmission amplifier for the transmission paths of the first frequency range and components for three further mobile radio systems.

### DETAILED DESCRIPTION

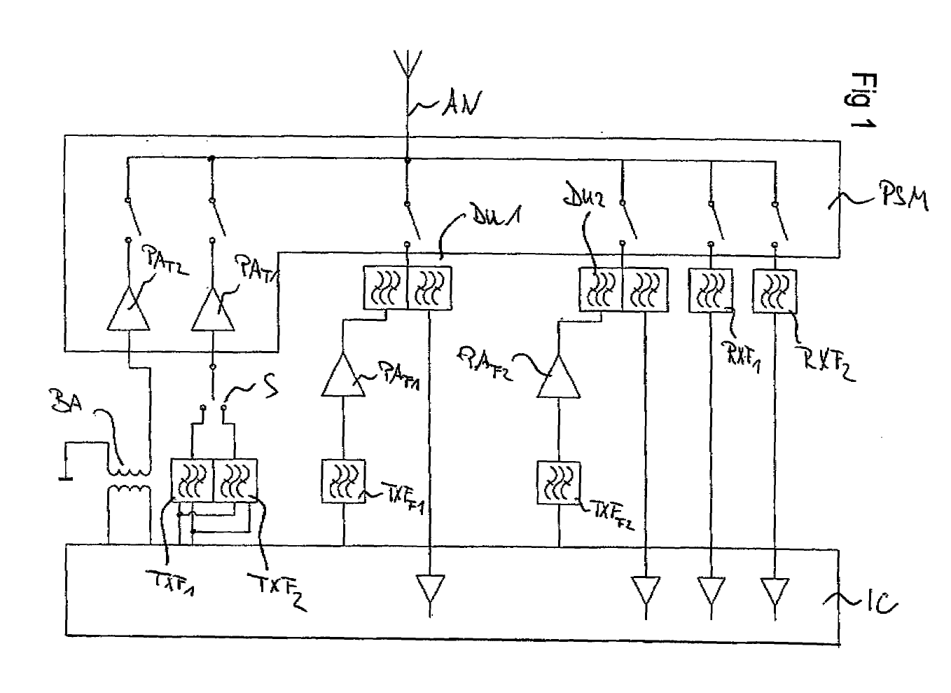

FIG. 1 shows the known front-end circuit already described at the outset, in which the first frequency range (in this case the frequency range to approximately 1 GHz) has two mobile radio systems with TDD operation and a respective transmission filter TXF₁, TXF₂ provided for it, the inputs of which are connected in parallel to a shared transmission output of the transceiver IC. The outputs of the transmission filters are connected to the TDD transmission path selectively by a switch S.

A first FDD mobile radio system has a duplexer DU, an FDD transmission path with an FDD transmission filter TXF_{F1}, an FDD transmission amplifier PA_{F1}, and an FDD reception path provided for it. The second frequency range has the components of a second FDD mobile radio system of similar design with the second duplexer DU2 and a second TDD mobile radio system provided for it. Furthermore, each TDD mobile radio system is provided with a separate reception path having a respective reception filter RXF₁ and RXF₂.

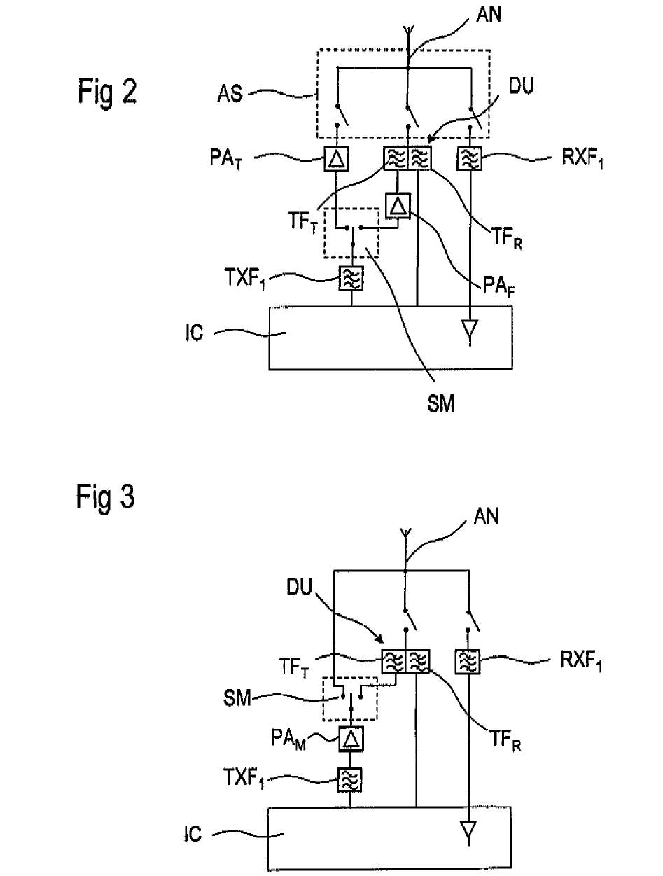

A first exemplary embodiment of a front-end circuit which is improved by contrast is shown in FIG. 2. An antenna switch AS can be used to selectively connect the transmission and reception paths for a first TDD mobile radio system (e.g. GSM 850 or GSM 900) and a duplexer DU for a first FDD mobile radio system (e.g. WCDMA 850 or WCDMA 900) to the antenna connection AN. The transmission path of the first TDD mobile radio system contains the first TDD transmission amplifier PA_{T}. The transmission path of the first FDD mobile radio system contains an FDD transmission amplifier PA_{F}. The reception path for the first FDD mobile radio system connects the reception filter element TF1 of the duplexer DU directly to the transceiver IC. The reception path of the first TDD mobile radio system contains the TDD reception filter RXF1.

The transmission output of the transceiver IC has a transmission filter TXF1 connected to it which can be connected either to the transmission path of the first TDD mobile radio system or to the transmission path of the first FDD mobile radio system once again by switching means SM which is in the form of an SPDT switch.

The reception path for the first TDD system contains a reception filter RXF1. The associated input amplifier (LNA) is integrated in the transceiver IC.

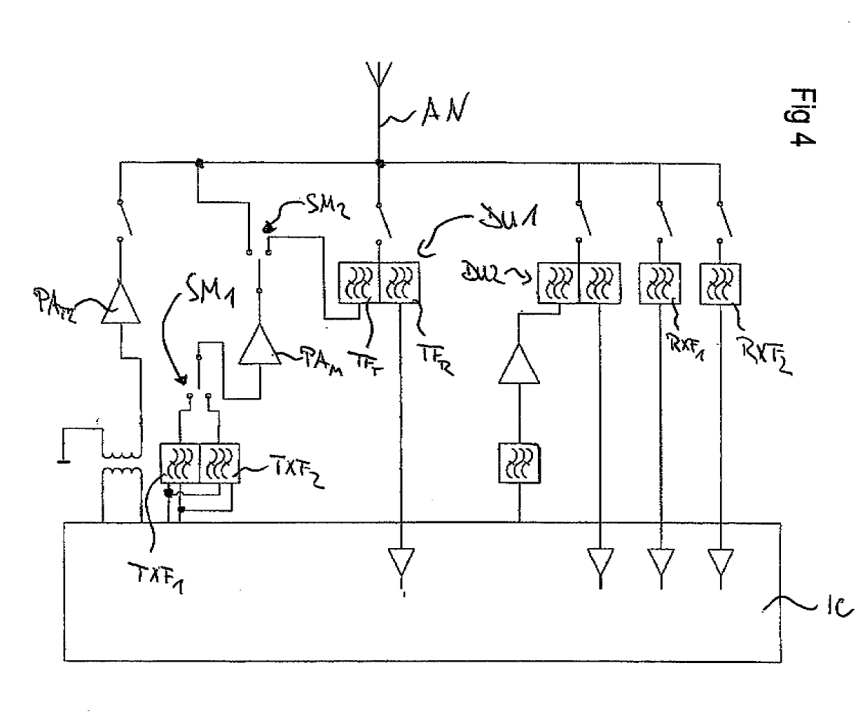

FIG. 3 shows a second exemplary embodiment, in which the shared transmission path for the first TDD and first FDD mobile radio systems additionally contains a shared transmission amplifier PA_{M} which can amplify the transmitted signals both for the TDD mobile radio system and for the FDD mobile radio system. The switching means SM, in this case again an SPDT switch, connects the shared transmission amplifier either to the transmission filter element TF_{T} of the duplexer DU (for operation in the FDD system) or to the antenna connection AN (for operation in the TDD mobile radio system).

FIG. 5 shows a front-end circuit which has been expanded by two further TDD mobile radio systems and a second FDD mobile radio system in comparison with the first and second exemplary embodiments. The first and second TDD mobile radio systems use adjacent bands of GSM 850 and GSM 900 MHz, for example, whereas the band of the third TDD mobile radio system operates in the frequency range up to 2 GHz. The first FDD mobile radio system with the first duplexer DU1 is associated with the same band as the first or the second TDD system.

In contrast to the first exemplary embodiment, two transmission filters TXF₁ and TXF₂ are provided for the first and second TDD systems, said transmission filters—in each case actuated symmetrically—both being connected electrically in parallel to the transmission output of the transceiver IC. Using the first and second switching means SM₁ and SM₂, which may also be implemented as a single switch switching a corresponding number of channels, the output of either the first or the second transmission filter is connected either to the transmission amplifier PA_{T1} of the first TDD system or to the transmission amplifier PA_{F} of the first duplexer. These are four switching options, only two of which can actually be switched during operation of the front-end circuit, however, since the FDD transmission path is connected only to the transmission filter with the relevant band. The other two switching options are provided for the option of replacing the first duplexer DU1 with the first band by a duplexer or equipping the front-end circuit with a duplexer which operates in the second band. The first TDD transmission amplifier can amplify the transmission frequencies of the first and second bands. The transmission path of the third TDD system, which operates in the 2 GHz frequency range, has a balun BA and transmission amplifier PA_{T2} for the second frequency range. The second FDD system, which operates in the second frequency range, is connected in conventional fashion with a separate transmission and reception path to the transceiver IC and the antenna connection AN in this case. A power switch module PSM comprises an antenna switch for the purpose of selectively connecting the different transmission and reception paths to the shared antenna connection AN and the two transmission amplifiers PA_{T1} and PA_{T2}.

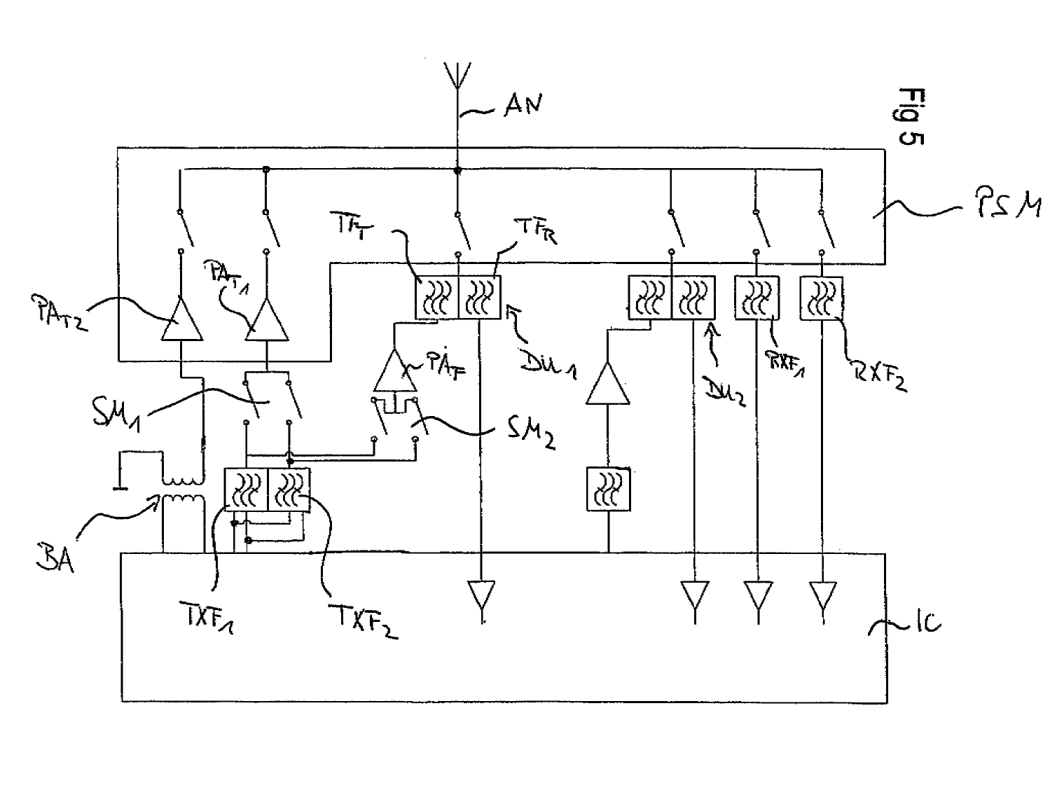

FIG. 4 shows a fourth front-end circuit, which is simplified in comparison with that in the third exemplary embodiment and in which the transmission amplifiers of the two TDD mobile radio systems and the first FDD mobile radio system, which all operate in the first frequency range, are implemented by a shared transmission amplifier PA_{M} operating in the mixed mode. The transmission amplifier is connected either to the first or to the second transmission filter TXF₁ or TXF₂ by a first switching means SM₁. A second switching means SM₂ connects the output of the shared transmission amplifier PA_{M} either to the transmission filter element of the first duplexer DU1 (for operation in the FDD system) or to the antenna connection AN (for operation in the TDD system). The antenna side of the front-end circuit differs in this case by dispensing with a power switch module, which means that antenna switches and amplifiers are provided as discrete components.

The remaining components of the front-end circuit correspond to those in the third exemplary embodiment. All reception amplifiers LNA are integrated in the transceiver IC. In this case too, the shared transmission path is connected to the transceiver IC symmetrically, whereas the reception paths are unbalanced. However, it is also possible to connect the shared transmission path in unbalanced form and to connect the reception paths symmetrically or to connect all paths symmetrically to the transceiver IC. In that case, either a respective balun BA as in the transmission path of the third TDD mobile radio system or an appropriate transmission or reception filter with integrated balun functionality is required, since the antenna connection is usually actuated in unbalanced form.

It is also possible, both here and in the other exemplary embodiments, to integrate all the components on a front-end module.

The claims are not limited to the exemplary embodiments and can comprise combinations of the individual features shown. It is also possible to extend the front-end circuit by components for further mobile radio systems. In the second frequency range too, it is possible, as in the first transmission filter, to be in shared use in line with the techniques described herein for TDD and FDD mobile radio systems.

1. A front-end circuit for a mobile radio, the front-end circuit comprising:
a first Frequency Division Duplexing (FDD) transmission path for a first FDD mobile radio system, the first FDD transmission path comprising a transmission amplifier and a duplexer comprising a transmission filter element;
a first Time Division Duplexing (TDD) transmission path for a first TDD mobile radio system, the first TDD transmission path comprising a transmission amplifier;
an antenna connection configured for connecting to the duplexer or to the first TDD transmission path;
at least one transmission filter; and
a switch configuration to connect the at least one transmission filter to the first FDD transmission path or to the first TDD transmission path;
wherein the first TDD mobile radio system and the first FDD mobile radio system use a same first frequency band.

2. The front-end circuit of claim 1, further comprising:
first transmission amplifier in the first FDD transmission path for the first FDD mobile radio system; and
a second transmission amplifier in the first TDD transmission path for the first TDD mobile radio system;
wherein the switch configuration is configured to connect the at least one transmission filter to the first transmission amplifier or to the second transmission amplifier.

3. The front-end circuit of claim 1, further comprising:
a shared transmission amplifier for use with the first FDD transmission path and with the first TDD transmission path
wherein the switch configuration is configured to connect the shared transmission amplifier to the transmission filter element of the duplexer or to the antenna connection.

4. The front-end circuit of claim 1, wherein the at least one transmission filter comprises a first transmission filter and a second transmission filter;
wherein the second transmission filter is for a second TDD mobile radio system, the second transmission filter being configured to operate using a second frequency band that is adjacent to the first frequency band; and
wherein the switch configuration is configured to connect the first transmission filter or the second transmission filter to the first FDD transmission path or to the first TDD transmission path.

5. The front-end circuit of claim 1, further comprising:
a TDD reception path for the first TDD mobile radio system; and
a transceiver connected to each transmission path and to each reception path.

6. The front-end circuit of claim 1, wherein the at least one transmission filter comprises a symmetric input and an unbalanced output.

7. The front-end circuit of claim 4, further comprising:
a second FDD transmission path comprising a second duplexer;
wherein the second duplexer is for a second FDD mobile radio system;
wherein the second duplexer comprises a transmission filter element, the transmission filter element of the second duplexer being in the second FDD transmission path; and
wherein the switch configuration comprises switches to connect the first transmission filter or the second transmission filter to the first FDD transmission path, to the second FDD transmission path, or to the first TDD transmission path.

8. The front-end circuit of claim 7, further comprising:
an additional FDD transmission path for an additional FDD mobile radio system;
an additional TDD transmission path for an additional TDD mobile radio system, the additional TDD mobile radio system and the additional FDD mobile radio system using a same third frequency band, the third frequency band being different from the first frequency band by an octave;
a shared third transmission filter for use with the additional FDD transmission path and the additional TDD transmission path; and
a switch configuration to connect the shared transmission filter to the additional TDD transmission path or to the additional FDD transmission path.

9. The front-end circuit of claim 1, further comprising:
an antenna switch configuration, the antenna switch configuration and the transmission amplifier for the TDD mobile radio system being on a shared power switch module (PSM).

10. The front-end circuit of claim 4, wherein the first transmission filter and the second transmission filter comprise a 2-in-1 filter.

11. The front-end circuit of claim 5, wherein the TDD reception path comprises a reception filter, the reception filter comprising a surface acoustic wave (SAW) filter or a Film Bulk Acoustic Resonator (FBAR) filter; and
wherein the duplexer comprises an SAW filter or an FBAR filter.

12. The front-end circuit of claim 1, wherein the at least one transmission filter comprises a surface acoustic wave (SAW) filter or a Film Bulk Acoustic Resonator (FBAR) filter.

13. The front-end circuit of claim 1, further comprising:
a ceramic multilayer substrate; and
circuitry interconnecting components comprising the front-end circuit, the circuitry being incorporated into the ceramic multilayer substrate, the circuitry comprising matching circuits.

14. The front-end circuit of claim 1, wherein the switch configuration comprises Complimentary Metal Oxide Silicon (CMOS) switches, PIN diodes, or GaAs switches, the switch configuration comprising at least one discrete component on a the substrate of the front-end circuit.
